(19) United States
(12) Patent Application Publication
(10) Pub. No.: US 2026/0088678 A1
(43) Pub. Date: Mar. 26, 2026

(54) Star Disk for a Rotor of a Current-Excited Machine, Rotor, Motor Vehicle, and Method for Producing a Star Disk

(71) Applicant: Bayerische Motoren Werke Aktiengesellschaft, Muenchen (DE)

(72) Inventors: Henryk FREUND, Markt Schwaben (DE); Ulrich LANDERSDORFER, Moosburg (DE); Kirstin STEINER, Muenchen (DE); Lena ULBRICHT, Freising (DE); Alexander WOLOSZYK, Feldkirchen (DE)

(21) Appl. No.: 19/338,490

(22) Filed: Sep. 24, 2025

(30) Foreign Application Priority Data
Sep. 25, 2024 (DE) 10 2024 127 791.2

(51) Int. Cl. H02K 3/52; B60L 50/51; H02K 1/24; H02K 13/00; H02K 15/122

(52) U.S. Cl. CPC H02K 3/527; H02K 1/24; H02K 13/003; H02K 15/122; B60L 50/51; H02K 2203/09

(57) ABSTRACT

A star disk for a rotor of a current-excited machine has a separately produced switching ring which includes a plurality of contact elements embedded in a first plastic material, which are configured so as to be connected to respective rotor windings of the rotor or to a slip ring of the current-excited machine, and which is retained on a base body of the star disk by overmolding with a second plastic material.

### CROSS REFERENCE TO RELATED APPLICATION

This application claims priority under 35 U.S.C. § 119 from German Patent Application No. 10 2024 127 791.2, filed Sep. 25, 2024, the entire disclosure of which is herein expressly incorporated by reference.

### BACKGROUND AND SUMMARY

The present disclosure relates to a star disk for a rotor of a current-excited machine, to a rotor, to a motor vehicle with an electric traction machine, and to a method for producing a star disk for a rotor.

DE 10 2021 122 066 A1 discloses a star disk for a rotor of an externally excited synchronous machine. At least the surface of the star disk is made from plastic in which busbars are embedded which in each case electrically conductively connect a pole shoe or a groove of the star disk to a pole shoe adjacent thereto or to a groove of the star disk adjacent thereto and which at their two ends in each case have a contacting element for receiving a winding wire which projects from the surface of the star disk.

An object of the present disclosure is to provide a solution which enables particularly simple positionally accurate arrangement of respective contact elements of a rotor with respect to rotor windings, to be contacted with the contact elements, of the rotor.

This object is achieved according to the present disclosure. Further possible embodiments are disclosed in the description and the Figures. Features, advantages, and possible embodiments which are explained within the scope of the description for one of the subject of the present disclosure are to be considered at least analogously as features, advantages, and possible embodiments of the respective subject of the other embodiments and any possible combination of the subjects of the embodiments, possibly in connection with one or more other embodiments.

The present disclosure relates to a star disk for a rotor of a current-excited machine. The current-excited machine is in particular a traction machine of a motor vehicle. The traction machine is configured so as to power the motor vehicle by electrical energy. The current-excited machine can also be referred to as an externally excited machine. In particular, the current-excited machine is a current-excited synchronous machine. The rotor of a current-excited machine usually comprises a rotor base body which has a plurality of salient poles. Wound around these salient poles of the rotor base body are a plurality of rotor windings. In order to be able to wrap these rotor windings around respective end sides of the rotor base body particularly simply and precisely for the winding, in the case of current-excited machines it is usually provided that a star disk is arranged in each case at respective end sides of the rotor base body. This star disk has a particularly robust form and has in particular rounded edges, as a result of which the rotor windings can be wrapped around the star disk particularly simply during the winding.

Furthermore, current-excited machines usually comprise respective contact elements by which the rotor windings of the rotor can be interconnected, and electrically conductive contacting of the rotor windings with a current source can be produced, usually via a slip ring. In order to enable particularly simple and safe and precise positioning of contact elements relative to the rotor windings, to be connected to the contact elements, of the rotor, it is provided that the star disk comprises a separately produced switching ring which comprises a plurality of contact elements embedded in a first plastic material. These contact elements are configured so as to be connected to the respective rotor windings of the rotor or to a slip ring of the current-excited machine. Crimp fork terminals and/or soldering lugs can, for example, be embedded in the first plastic material as contact elements. The crimp fork terminals are configured so as to be connected to the respective rotor windings of the rotor by crimping. The soldering lugs are configured so as to be electrically conductively connected to the slip ring by soldering. Alternatively, the respective contact elements can be configured so as to be connected to the rotor windings or the slip ring via a screw connection and/or via a plug-in connection. The switching ring can have been produced separately, for example, as a so-called pre-molded part. The switching ring can comprise lines embedded in the first plastic material, by which at least individual contact elements of the switching ring are electrically conductively connected to one another for interconnection of the rotor windings.

In the case of the star disk, it is furthermore provided that the switching ring is retained on a base body of the star disk by overmolding with a second plastic material. The separately produced switching ring can thus have been integrated into the base body of the star disk by overmolding with the second plastic material or fastened to the base body. Because the contact elements are already fixed relative to one another in the separately produced switching ring, it can be achieved that, also when the switching ring is fixedly connected to the base body by the overmolding with the second plastic material, the contact elements integrated into the star disk are positioned precisely relative to one another and are retained fixedly on the star disk. The risk of relative displacement of the contact elements with respect to the base body of the star disk in the electric machine, in particular during operation, can be avoided particularly well as a result. If the contact elements were to be embedded directly in the second plastic material without being embedded in the first plastic material when the star disk is produced, the contact elements could then tilt or be displaced relative to one another during potting with the second plastic material, as a result of which they would no longer be oriented precisely relative to one another. Because the switching ring is produced separately, a production method of the switching ring can be adapted in such a way that the latter is oriented such that the contact elements remain oriented precisely relative to one another and do not tilt or are not displaced relative to one another during embedding in the first plastic material. When the switching ring thus produced is overmolded with the second plastic material, it can be oriented in a further process so as to optimize the production of the star disk, in particular the production of the base body or the potting of the base body with the second plastic material. The risk of the contact elements being displaced relative to one another or with respect to the base body of the star disk is particularly low in the case of this star disk produced step by step, such that the contact elements are oriented particularly precisely relative to one another in the star disk. Because the contact elements are oriented particularly precisely relative to one another and relative to the base body of the star disk, the contact elements can be connected to and electrically contacted with respective associated rotor windings. The first plastic material can differ from the second plastic material or the same plastic material can be used as the first plastic material and as the second plastic material. The first plastic material and/or the second plastic material is or are in particular a thermoset or a thermoplastic.

In a possible development of the present disclosure, it is provided that the base body of the star disk and the switching ring are overmolded or potted jointly with the second plastic material. For example, the base body of the star disk can be a steel base body. This steel base body can be produced, for example, as a forged part. The switching ring and the base body of the star disk can thus be jointly overmolded or potted with the second plastic material. As a result, the base body and the switching ring are retained against each other by the second plastic material. It is possible that the switching ring bears directly against the base body, and the base body and the switching ring are encased at least in some areas by the second plastic material, as a result of which the switching ring is retained on the base body of the star disk. Because the base body and the switching ring are manufactured separately from each other, they can then be oriented precisely relative to each other and are fixed relative to each other in this position oriented precisely relative to each other by being encased at least in some areas with the second plastic material. Particularly secure retention of the switching ring on the base body of the star disk can thus be ensured.

As an alternative to the design of the star disk in such a way that it comprises the separately manufactured base body which is overmolded or potted jointly with the switching ring with the second plastic material, the base body of the star disk can be produced by being injection-molded onto or potted onto the switching ring. The respective salient poles of the star disk can thus be injection-molded onto or potted onto the switching ring with the second plastic material. In addition, a yoke of the base body of the star disk can be injection-molded onto or potted onto the switching ring. This means that the base body can be produced entirely from the second plastic material by the switching ring being placed inside an injection-molding mold or a potting mold and the base body made from the second plastic material being injection-molded onto or potted onto the switching ring.

The present disclosure furthermore relates to a rotor with a rotor base body and at least one star disk arranged on the end side of the rotor base body, as has already been described in connection with the star disk according to the present disclosure. In particular, the rotor has in each case one star disk at each end side of the rotor base body. The rotor base body can in particular take the form of a lamination stack. Wrapped around the respective star disk are rotor windings of the rotor which are wound around the rotor base body. It is furthermore provided that the respective rotor windings of the rotor are connected to the contact elements embedded in the switching ring and consequently electrically contacted, as a result of which the rotor windings are electrically interconnected. Because the contact elements are oriented and positioned particularly precisely relative to the base body of the star disk, the rotor windings can be connected particularly simply to the contact elements. Because the switching ring is oriented precisely relative to the base body of the star disk, the switching ring has a precise orientation with respect to the rotor windings of the rotor. It can be ensured as a result that the rotor windings are electrically interconnected particularly reliably via the switching ring in accordance with a predetermined interconnection arrangement.

The present disclosure furthermore relates to a motor vehicle with an electric traction machine which is in particular a current-excited synchronous machine which comprises a stator and a rotor which can rotate about an axis of rotation relative to the stator, wherein the rotor is formed so that it corresponds to the already described rotor according to the present disclosure. Because the rotor comprises the already described star disk according to the present disclosure, the risk of relative displacement of the switching ring of the rotor relative to the base body of the star disk is particularly low, as a result of which reliable interconnection of the rotor windings of the rotor of the electric traction machine can be ensured by the switching ring.

The present disclosure furthermore relates to a method for producing a star disk for a rotor, in particular a rotor of an electric traction machine of a motor vehicle. In the method, a switching ring is produced by embedding respective contact elements in a first plastic material. The contact elements can here be embedded in the first plastic material by the contact elements being overmolded or potted with the first plastic material. The switching ring thus produced is then fastened to a base body of the star disk by overmolding with a second plastic material. The switching ring is consequently integrated into the star disk, as a result of which the risk of relative displacement of the respective contact elements relative to one another and to the base body of the star disk can be kept particularly low. The star disk is thus produced in a two-stage plastic potting or plastic injection-molding method.

In a possible development of the present disclosure, it is provided that, for producing the switching ring, the contact elements are positioned relative to one another in a mold by at least one hold-down device whilst the contact elements are potted or overmolded with the first plastic material. By the at least one hold-down device, the contact elements can be oriented particularly precisely relative to one another and prevented from moving relative to one another or falling over during the overmolding with the first plastic material. After the contact elements have been fixed relative to one another by the first plastic material, the at least one hold-down device can be released and openings in the switching ring which may have been kept clear by the hold-down device can be closed, for example by potting with the first plastic material.

In a further possible embodiment of the present disclosure, it is provided that the switching ring is applied to the base body of the star disk and is overmolded or potted jointly with the star disk with the second plastic material. The base body of the star disk can be produced, for example, from a metal material. For fastening the switching ring on the base body of the star disk, the base body of the star disk and the switching ring are thus overmolded or potted jointly with the second plastic material at least in some areas, as a result of which, after the second plastic material has hardened, the switching ring is retained on the base body of the star disk by the second plastic material.

Because the switching ring and the base body are potted with the second plastic material, the second plastic material can form an undercut via which the base body of the star disk and the switching ring are fixed in their position relative to each other.

In this connection, in a further embodiment of the present disclosure it can be provided that the base body of the star disk has a central opening into which an axially protruding collar of the switching ring is plugged. The switching ring can consequently be centered radially relative to the base body. The axially protruding collar can thus be applied with its radially outer external face against an inner wall, radially inwardly delimiting the opening of the base body of the star disk, of the base body, in particular can be applied circumferentially. The switching ring is thus oriented particularly precisely relative to the base body and can then be retained in this position on the base body by overmolding or potting with the second plastic material. The plugging of the switching ring with the collar into the opening of the base body ensures that the switching ring is arranged precisely in a predetermined position relative to the base body before the switching ring is fastened to the base body by potting or overmolding with the second plastic material.

In a further possible embodiment of the present disclosure, it is provided that the base body of the star disk is forged from the metal material. The metal material is in particular steel. The forging of the base body enables particularly simple and quick production of the base body with a precise contour.

Further features of the present disclosure can be found in the claims, the Figures, and the description of the Figures. The features and combinations of features mentioned above in the description, as well as the features and combinations of features mentioned below in the description of the Figures and/or shown solely in the Figures, can be used not only in the combination specified in each case but also in other combinations or on their own without going beyond the scope of the invention.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a schematic perspective view of a switching ring;

FIG. 2 shows a schematic plan view of the switching ring which is applied to a base body of a star disk; and

FIG. 3 shows a schematic plan view of the switching ring and of the base body of the star disk, which are overmolded or potted jointly with a plastic material.

### DETAILED DESCRIPTION OF THE DRAWINGS

Identical and functionally identical elements are provided in the Figures with the same reference signs.

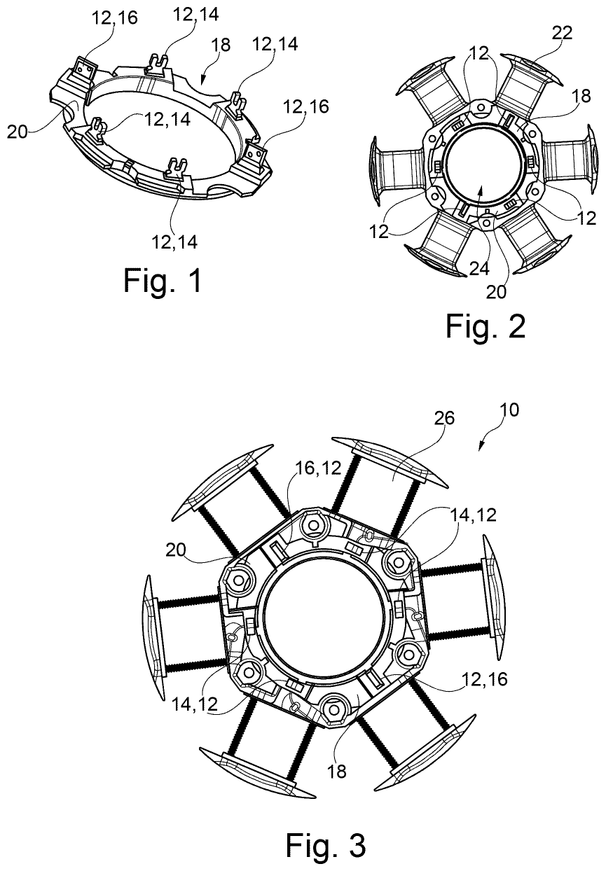

Shown in FIG. 3 is a star disk 10 for a rotor of a current-excited machine of a motor vehicle. Shown in FIGS. 1 and 2 are respective intermediate stages in the production of the star disk 10. The star disk 10 is configured so as to be applied to an end side of a rotor base body of the rotor. Respective rotor windings of the rotor which are wound around respective salient poles of the rotor base body can consequently be wrapped around the star disk 10 arranged on the end side of the rotor base body for the winding. The respective rotor windings of the rotor are to be electrically interconnected and electrically contacted with a slip ring of the electric machine for energizing the respective rotor windings. For this purpose, the star disk 10 has a plurality of contact elements 12, some of which in the present case take the form of crimp fork terminals 14 and others the form of soldering lugs 16. The crimp fork terminals 14 are configured so as to be crimped to respective rotor windings of the rotor, as a result of which the rotor windings can be interconnected. In particular, the crimp fork terminals 14 are connected to one another for the interconnection of the rotor windings by respective electrically conductive connections. The crimp fork terminals 14 can be designed as tin-plated. The soldering lugs 16 are configured so as to be electrically contacted with a slip ring of the rotor. The soldering lugs 16 can be provided with a wafer of solder, in particular hard solder or soft solder.

For the production of the star disk 10, it is provided that first a switching ring 18 shown in FIG. 1 is produced. For the production of the switching ring 18, the contact elements 12 are oriented relative to one another, for example by at least one hold-down device, and then the contact elements 12 are embedded in some areas in a first plastic material 20. For this purpose, the contact elements 12 can be potted or overmolded with the first plastic material 20. The switching ring 18 thus produced, which is a pre-molded part, is then applied to a base body 22 of the star disk 10, as shown in FIG. 2. In the present case, it is provided that the base body 22 is produced as a forged part from a metal material. The base body 22 has in the center a circular opening 24 into which a collar protruding axially from the switching ring 18 is plugged at least in some areas. The switching ring 18 is consequently centered radially relative to the base body 22 by a circumferential outer surface, delimiting the collar radially on the outside, of the switching ring 18 being applied over its whole circumference against an inner wall, delimiting the opening 24 of the base body 22 radially on the inside, of the base body 22. The switching ring 18 and the base body 22 are then jointly overmolded or potted with a second plastic material 26, as a result of which the star disk 10, as shown in FIG. 3, is produced. In particular, it is provided in the present case that the base body 22 of the star disk 10 is completely encased by the switching ring 18 and the second plastic material 26. At least the contact elements 12 of the switching ring 18 are free of the plastic materials at least in some areas in order to enable particularly simple and reliable electrical contacting of the contact elements 12 with the rotor windings or with the slip ring. The star disk 10 thus comprises in the present case the base body 22 and the switching ring 18 manufactured separately from the base body 22 which are potted or overmolded jointly with the second plastic material 26, as a result of which the switching ring 18 is retained on the base body 22 and fixed in its relative position with respect to the base body 22 by this second plastic material 26 after the second plastic material 26 has hardened. The star disk 10 is configured so as to contact poles of the rotor with one another and with respect to the slip ring via the switching ring 18.

If the switching ring 18 were not retained on the base body 22 of the star disk 10 via the second plastic material 26, the ability of the switching ring 18 to be displaced with respect to the star disk designed separately from the switching ring 18 could cause a high positional tolerance of the crimp fork terminals with respect to contacts of the rotor windings and of the soldering lugs 16 with respect to the slip ring, which is counterproductive for a high degree of process safety during the contacting. If the contact elements 12 were to be integrated directly into insulation of a star disk and thus into the second plastic material 26, it might not be possible, or only with a very high degree of technical complexity, for these contact elements 12 to be retained in situ in an overmolding process. There would then be a risk during the overmolding that the contact elements 12 float around because of the injection pressure and thus not maintain their minimum distance, relevant for the electric breakdown strength, from the base body 22. In order to overcome these disadvantages, it is provided in the case of the star disk 10 shown in the Figure that the contact elements 12, which in particular take the form of copper contact bridges, are integrated into the pre-molded part which is the switching ring 18. This switching ring 18 is overmolded, jointly with the base body 22 of the star disk 10, with the electrically insulating second plastic material 26. By virtue of this step-by-step production of the star disk 10, displacement of the contact elements 12 during the overmolding of the switching ring 18 with the second plastic material 26 is avoided. Positioning of the contact elements 12 so that they cannot twist and are stationary with respect to the rotor windings can nevertheless be ensured. This results in a particularly high degree of process safety when connecting the crimp fork terminals 14 to the rotor windings.

As a whole, the present disclosure shows how the star disk 10 can be provided with the fixedly potted switching ring 18 The foregoing disclosure has been set forth merely to illustrate the present disclosure and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 star disk
12 contact element
14 crimp fork terminal
16 soldering lug
18 switching ring
20 first plastic material
22 base body of the star disk
24 opening
26 second plastic material

What is claimed is:

1. A star disk for a rotor of a current-excited machine, comprising:
a separately produced switching ring which comprises a plurality of contact elements embedded in a first plastic material, wherein the plurality of contact elements are configured to be connected to respective rotor windings of the rotor or to a slip ring of the current-excited machine, and which is retained on a base body of the star disk by overmolding with a second plastic material.

2. The star disk according to claim 1,
wherein the base body of the star disk and the switching ring are overmolded or potted jointly with the second plastic material.

3. A rotor comprising:
a rotor base body;
the star disk according to claim 1 arranged on an end side of the rotor base body; and
rotor windings of the rotor that are wound around the rotor base body.

4. A motor vehicle comprising:
an electric traction machine comprising a stator and the rotor according to claim 3, wherein the rotor rotates relative to the stator about an axis of rotation.

5. A method for producing a star disk for a rotor, comprising:
producing a switching ring by embedding respective contact elements of the switching ring in a first plastic material; and
subsequently fastening the switching ring to a base body of the star disk by overmolding with a second plastic material.

6. The method according to claim 5, comprising:
positioning the contact elements relative to one another in a mold by at least one hold-down device while the contact elements are potted or overmolded with the first plastic material.

7. The method according to claim 5, comprising:
applying the switching ring to the base body of the star disk; and
overmolding or potting jointly the switching ring with the star disk with the second plastic material.

8. The method according to claim 7, comprising:
plugging an axially protruding collar of the switching ring into a central opening of the base body of the star disk, wherein the switching ring is resultantly centered radially relative to the base body.

9. The method according to claim 7, comprising:
forging the base body of the star disk from a metal material.
